(19) United States
(12) Patent Application Publication
(10) Pub. No.: US 2025/0210925 A1
(43) Pub. Date: Jun. 26, 2025

(54) Mount for a Measuring Device

(71) Applicant: Robert Bosch GmbH, Stuttgart (DE)

(72) Inventors: Alexander Hills, Belvidere, IL (US); William Schwarzkopf, Chicago, IL (US); Ivan Abakumov, Chicago, IL (US); Brandon Eble, Chicago, IL (US)

(21) Appl. No.: 18/391,103

(22) Filed: Dec. 20, 2023

(51) Int. Cl. H01S 3/02; G01C 15/00; G01D 11/30

(52) U.S. Cl. CPC H01S 3/025; G01C 15/004; G01D 11/30

(57) ABSTRACT

A mount for a measuring device, for example a laser level, includes a first mounting member having a first mounting surface that defines a first plane and includes at least one first magnet, a second mounting member having a second mounting surface that includes at least one second magnet, and a measuring device support configured to support the measuring device. The second mounting member has a first position at which the second mounting member extends on an opposite side of the first plane from the measuring device support and the first and second mounting surfaces are substantially perpendicular to one another.

### FIELD

This disclosure relates generally to measuring tools, and, more particularly, to mounting arrangements for measuring tools.

### BACKGROUND

Measuring tools are used in construction trades and surveying applications to measure distances, determine level planes, and otherwise assist a worker in precision for construction activities. For example, measuring tools may include laser levers, laser receivers, rangefinders, and the like. In particular, laser levels are commonly used to project one or more precisely horizontal and/or vertical lines on a wall. In particular, conventional laser levels are designed to be mounted directly on the wall surface on which the line is to be projected. In some conventional laser levels, this requires using a fastener, e.g., a screw, to mount the laser level to the wall. In some other laser levels, an adhesive may be used to attach the laser level to the wall. Both of these solutions, however, can cause damage to the surface on which the laser line is projected.

When the laser level is used on a finished wall, for example on drywall, it is typically undesirable to damage the wall on which the laser line is projected. Some conventional laser levels use magnetic mounting arrangements to attach the laser level to a magnetic surface behind or in the drywall. However, because the magnetic mounting arrangement is separated from the magnetic surface by drywall and/or drywall compound, the strength of the connection of such magnetic mounting arrangements may be insufficient to reliably support the laser level on the surface.

What is needed, therefore, are improvements in laser level mounting arrangements that avoid damage to the wall surface to which the laser level is mounted, and that can reliably support the laser level on the wall.

### SUMMARY

In one embodiment, a mount for a measuring device includes a first mounting member having a first mounting surface that defines a first plane and includes at least one first magnet, a second mounting member having a second mounting surface that includes at least one second magnet, and a measuring device support configured to support the measuring device. The second mounting member has a first position at which the second mounting member extends on an opposite side of the first plane from the measuring device support and the first and second mounting surfaces are substantially perpendicular to one another.

In another embodiment, a measuring device system comprises a measuring device and a mount. The mount includes a first mounting member having a first mounting surface that defines a first plane and includes at least one first magnet, a second mounting member having a second mounting surface that includes at least one second magnet, and a measuring device support configured to support the measuring device. The second mounting member has a first position at which the second mounting member extends on an opposite side of the first plane from the measuring device support and the first and second mounting surfaces are substantially perpendicular to one another.

### BRIEF DESCRIPTION OF THE DRAWINGS

FIG. 1 is a front perspective view of a measuring device system, in particular a laser level system, having a mount magnetically attached to a drywall bead of an external corner of a wall and in which the second mounting member is in a first position.

FIG. 2 is a front perspective view of the mount of the measuring device system of FIG. 1.

FIG. 3 is a front perspective view of the mount of the measuring device system of FIG. 1 showing the second mounting member in a second position.

FIG. 4 is a front perspective view of another mount for a measuring device system showing the second mounting member in a third position.

FIG. 5 is a rear perspective view of a measuring device system having a mount configured to magnetically attach to a surface or corner in which the second mounting member is in a first position.

FIG. 6 is a right side perspective view of the measuring device system of FIG. 5 in which the second mounting member is in the first position.

FIG. 7 is a left side plan view of the measuring device system of FIG. 5 with the second mounting member in a second position.

### DETAILED DESCRIPTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

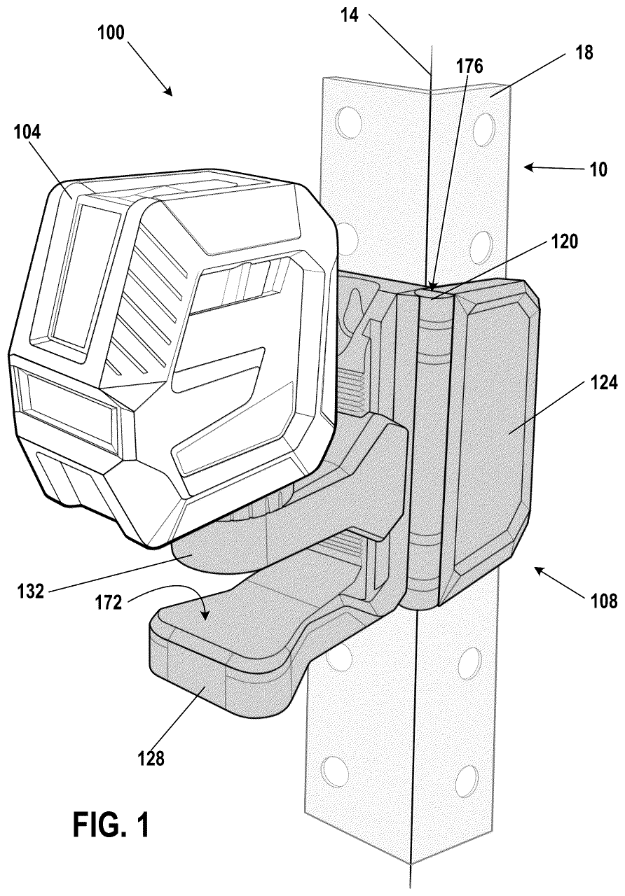

FIG. 1 depicts a measuring device system 100, in particular a laser level system, having a measuring device, which is configured as a laser level 104, and a mount 108. The mount 108 is configured to attach to a wall 10, in particular a corner 14 of the wall 10 in which a corner bead 18 formed of a ferromagnetic material is present.

The laser level 104 is configured to project at least one laser line onto a surface. In one embodiment, the laser level 104 may be a self-leveling laser level configured to generate a horizontal laser line projecting away from the wall 10 on which the laser level 104 is mounted. In various embodiments, the laser level 104 may be further configured to generate one or more horizontal lines onto the surfaces of the wall 10, one or two vertical laser lines, and/or a 360-degree scanning horizontal laser line. While the measuring device system 100 of FIG. 1 depicts the measuring device as a laser level, the reader should appreciate that the measuring device may include, for example, a laser rangefinder, laser receiver, or another suitable accessory supported by the mount 108.

The mount 108 includes a first mounting member 120, a second mounting member 124, a horizontal member 128, and a laser support 132. The first mounting member 120 and the horizontal member 128 are fixedly connected to one another and, in some embodiments, are integrally formed as one piece. The first member 132 includes a through hole 136 that enables the mount 108 to be installed on a surface in a conventional manner via a fastener. In addition, the first mounting member 120 includes an attachment mechanism 140 that includes a plurality of horizontal ridges 144 and two vertical grooves 148 for adjustably attaching the support laser support 132.

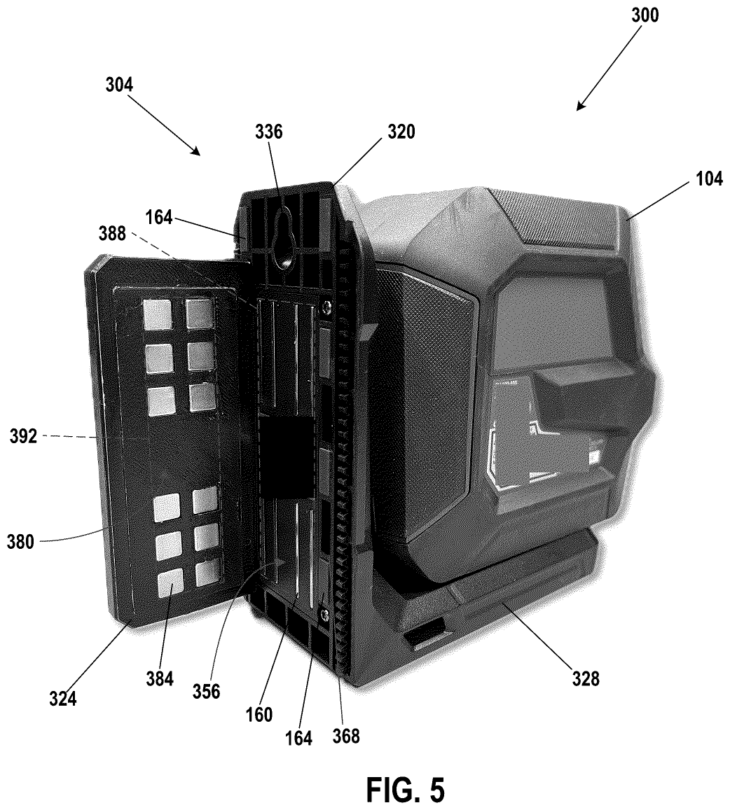

The first mounting member 120 also includes a first mounting surface 156 in which a plurality of magnets 160 (not visible in FIGS. 1-3, but configured similar to that shown in the embodiment of FIG. 5) are arranged so as to be substantially flush with the first mounting surface 156. The magnets 160 are configured to magnetically mount the first mounting surface 156 to the wall 10 via a magnetic attraction force generated between the magnets 160 and the ferromagnetic material of the drywall track 18. The first mounting surface 156 may also include one or more rubber pads 164 designed to avoid damage to the wall 10 when the first mounting surface 156 is mounted thereto.

As noted above, the laser support 132 is attached to the first mounting member in a vertically adjustable manner via the attachment mechanism 140. In particular, the laser support 132 extends in a direction toward the front of the mount 108 or, in other words, opposite the direction the first mounting surface 156 faces. Additionally, the laser support 132 includes a connector 168 for connecting the laser support 132 to the laser level 104. In the illustrated embodiment, the connector 168 is configured as a threaded fastener with a relatively large hand-manipulatable knob that is screwed into a corresponding threaded opening on the bottom of the laser level 104. The reader should appreciate, however, that other suitable connectors may be used in alternative embodiments.

The horizontal member 128 extends outwardly from the first mounting member 120 beneath the laser support 132 and in the same direction as the laser support 132. The horizontal member 128 has a generally flat upper surface 172, which can support the laser level 104 in some configurations (e.g., FIGS. 5-7). Thus, in some embodiments, the horizontal member 128 functions as the laser support.

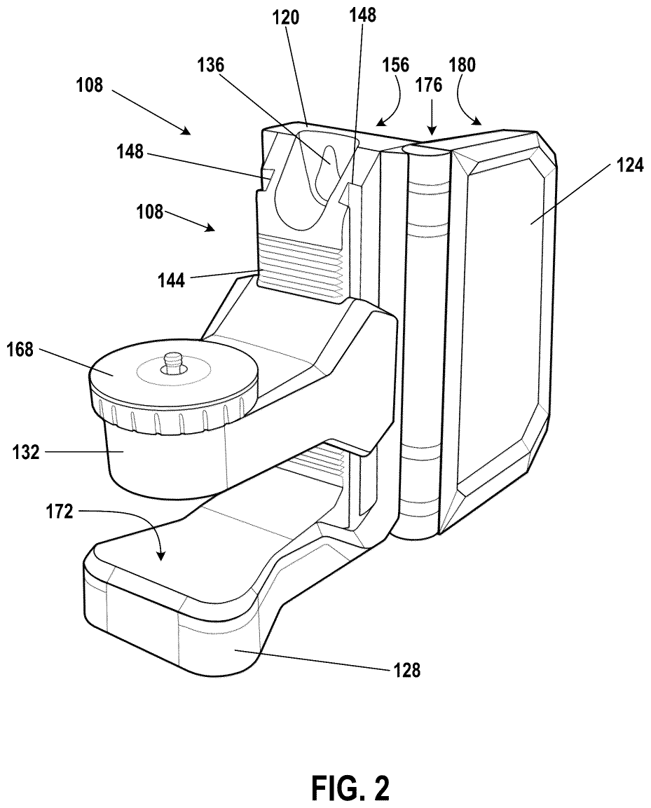

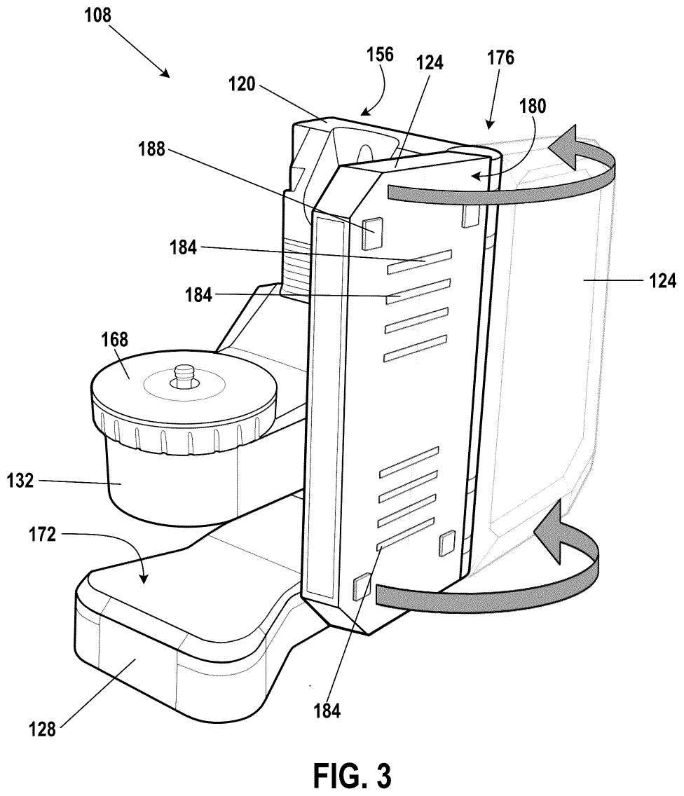

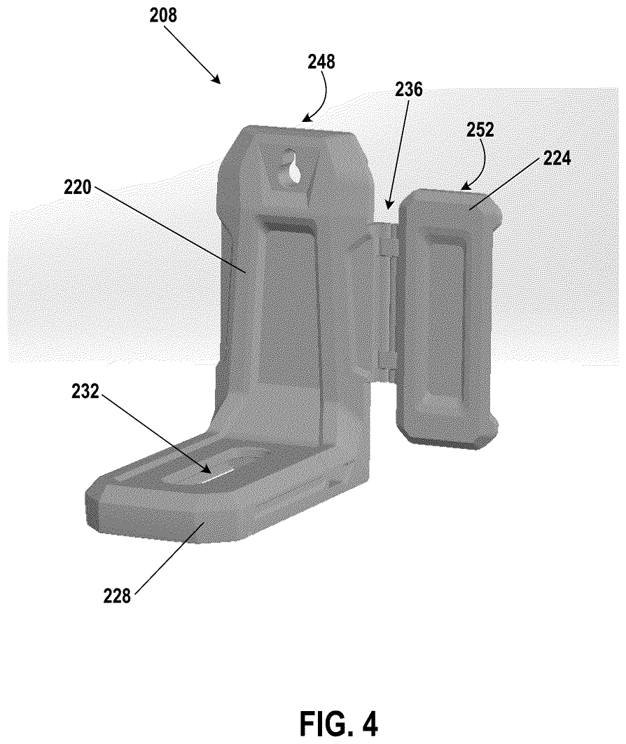

The second mounting member 124 is pivotably connected to the first mounting member 120 via, for example, a hinge 176. As a result, the second mounting member 124 can be positioned in several positions relative to the first mounting member 120. In particular, the second mounting member 124 may be positioned in a first position at which the second mounting member 124 is perpendicular or substantially perpendicular to the first mounting member 120 and extends away from (i.e. to the opposite side of the plane defined by the first mounting surface 156 from) the horizontal member 128 and the laser support 132, as shown in FIGS. 1 and 2. In a second position, the second mounting member 124 extends perpendicularly or substantially perpendicularly to the first mounting member, but extends in the same direction as the horizontal member 128 and laser support 132 (i.e. extending to the same side of the plane defined by the first mounting surface 156), as shown in FIG. 3. In a third position, the second mounting member 124 is parallel or coplanar with the first mounting member 120, similar to the depiction shown in FIG. 4. The hinge 176 has a hinge axis that runs substantially parallel to or coincident with the plane of the first mounting surface 156.

The second mounting member 124 also includes a second mounting surface 180 in which a plurality of magnets 184 are arranged so as to be substantially flush with the second mounting surface 180. The second mounting member 124 is configured such that, particularly in the first position in which the second mounting member 124 extends away from the laser support 132, the plurality of magnets 184 magnetically mount the second mounting surface 180 to the wall 10 via a magnetic attraction force generated between the magnets 184 and the ferromagnetic material of the corner bead 18. As with the first mounting surface 156, the plane of the second mounting surface 180 is also substantially parallel to or coincident with the hinge axis of the hinge 176. In addition, similarly to the first mounting surface 156, the second mounting surface 180 may also include one or more rubber pads 188 designed to avoid damage to the wall 10 when the second mounting surface 180 is mounted thereto.

To use the measuring device system 100, the user attaches the laser support 132 to the first mounting member 120 via the attachment mechanism, and connects the laser level 104 to the connector 168 of the laser support 132. Alternatively, the user may remove the laser support 132 from the first mounting member 120 if it is desired to rest the laser level 104 on the surface 172 of the horizontal member 128.

The user also attaches the first mounting member 120 to a corner of a magnetic surface, for example the corner 14 of the wall 10 or a corner of a metallic door frame, at the desired location. Specifically, the magnets 160 magnetically couple the first mounting member 120 to the ferromagnetic corner bead 18 via a magnetic attraction force.

The second mounting member 124 is pivoted about the hinge 176, either before or after the first mounting member 120 is attached to the wall, such that the second mounting member 124 is arranged in the first position in which it is substantially perpendicularly to the first mounting member and extends in a direction away from the laser support 132 and on the opposite side of the plane of the first mounting surface 156 from the laser support 132. As a result, the magnets 184 of the second mounting member 124 magnetically couple the second mounting member 124 to the portion of the ferromagnetic corner bead 18 that is perpendicular to the portion to which the first mounting member 124 is attached.

As a result of the two sets of magnets 160, 184 supporting the mount 108, the mount 108 of the present disclosure enables a significantly stronger magnetic force to retain the mount 108 in the desired position. In various embodiments, for example, the second set of magnets 184 may be from 50% to 200% of the strength of the first set of magnets 160, from 75% to 150% of the strength of the first set of magnets 160, or from 90%-125% of the strength of the first set of magnets 160.

Because of the hinged connection between the first and second mounting members 120, 124, the mount 108 can also be mounted to a wall in the conventional manner. Specifically, in the second position shown in FIG. 3, the second mounting member 124 is generally perpendicular to the first mounting member 120, but extends relative to the plane of the first mounting surface 156 in the same direction as the laser mount 132. In this configuration, the second mounting member 124 does not interfere with the mount 108 being installed on a flat wall surface that extends laterally beyond the second mounting surface 124. In particular, the mount 108 may be installed via the magnetic connection of the first magnets 160 to a ferromagnetic surface, or it may be installed using a screw passing through the through hole 136 in the first mounting member 120. Additionally, in the configuration depicted in FIG. 3, the magnets 184 of the second mounting member 124 can be used in conjunction with the magnets 160 of the first mounting member 120 to magnetically couple the mount 108 to the drywall bead of an interior corner in a similar manner as to the exterior corner depicted in FIG. 1.

The second mounting member 124 of the mount 108 depicted in FIGS. 1-3 also has a third position in which the second mounting member 124 is pivoted about the hinge 176 such that the first and second mounting surfaces 156, 180 are generally coplanar with one another. In this third configuration, the mount 108 can be attached to a ferromagnetic surface that has a longer horizontal width than a typical drywall corner bead to obtain the increased strength of magnetic connection noted above.

In addition, the reader should appreciate that the mount 108 can be attached to a surface in orientations different from those depicted in FIGS. 1-3. For example, in some instances, it may be desirable to arrange the mount 108 upside down or rotated clockwise or counterclockwise by 90 degrees from the orientations shown in FIGS. 1-3, depending on the availability of structures to which the mount 108 can be mounted.

FIG. 4 depicts another embodiment of a mount 208 for a measuring device, e.g. the laser level 104 depicted above, that is similar to the mount 108 described above. As in the previous embodiment, the mount 208 includes a first mounting member 220, a second mounting member 224, and a horizontal member 228. There is, however, no separate laser support 132, as the horizontal member 228 serves as the laser support in the embodiment of FIG. 4. Specifically, the mount 208 is configured such that the laser level 104 is rested on the upper surface of the horizontal member 228 and, if desired, can be fastened thereto by inserting a fastener through a through slot 232 defined in the horizontal member 228 and into a corresponding threaded hole in the laser level 104.

The horizontal member 228 is fixedly connected to the first mounting member 220, while the first and second mounting members 220, 224 are pivotably connected to one another by a hinge 236 in a similar manner as in the mount 108. Each of the first and second mounting members 220, 224 includes a corresponding mounting surface 248, 252 that has a plurality of magnets (not shown) configured similar to the other embodiments described herein.

In the mount 208, the second mounting member 224 has a smaller size than the first mounting member 220. Specifically, the surface area of the second mounting surface 252 may be between approximately 25% and 75% of the surface area of the first mounting surface 248, and in some embodiments, between approximately 40% and 60% of the surface area of the first mounting surface 248.

The mount 208 of FIG. 4 is used in essentially the same manner as described above with regard to the embodiment of FIGS. 1-3. In particular, the second mounting member 224 may be pivoted relative to the first mounting member 220 by to the hinge 236 such that the second mounting member 224 is in a first position in which it extends away from the horizontal member 228 to enable the mount 208 to be mounted to the drywall bead 18 of an exterior corner 14 of a wall 10. As with the previous embodiment, the mount 208 may also be configured with the second mounting member 224 pivoted to a second position in which it extends in the same direction as the horizontal member 228 to enable mounting to a flat surface or magnetic mounting to an interior corner. Alternatively, the first and second mounting members 220, 224 may be positioned in the third position shown in FIG. 4 such that the two mounting surfaces 248, 252 are generally coplanar to arrange the mount 208 on a flat surface or an extended ferromagnetic surface.

FIGS. 5-7 depict another measuring device system 300 having a mount 308 configured to magnetically mount a measuring device, for example the laser level 104, to a drywall corner bead. The mount 308 has a first mounting member 320, a second mounting member 324, and a horizontal member 328 that is fixedly connected to and extends away from the first mounting member 320 and that serves as the laser support. As with the embodiment of FIG. 4, the horizontal member 328 includes a hole or slot (not shown) via which the laser level 104 can be mounted to the horizontal member 328.

The first mounting member 320 has a first mounting surface 356 in which a plurality of magnets 160 are arranged. As discussed in detail above, the magnets 160 facilitate magnetically mounting the first mounting member 320 to a magnetic structure. In the embodiment depicted in FIG. 5, the first mounting surface 356 includes eight linear magnets 160 arranged in two rows of four. The reader should appreciate, however, that different numbers or arrangements of magnets may be present in other embodiments. In addition, the first mounting surface 356 includes a plurality of rubber pads 164 that rest against the surface to which the first mounting member 320 is mounted in such a way as to avoid damage to the surface.

The second mounting member 324 is attached to the first mounting member 320 by a supporting arrangement 364 that includes two vertically-extending supporting recesses 368 on either side of the first mounting surface 356. The recesses 368 receive corresponding hook structures (not shown) on the end side of the second mounting member 324 in such a way that the second mounting member 324 is securely, yet releasably, supported by the first mounting member 320. The hook structures of the second mounting member 324 may be double-sided hooks configured such that the second mounting member 324 may be removed from one side of the first mounting surface 356, rotated 180 degrees about the horizontal center of the mount 308, and installed in the supporting recesses 368 on the opposite side of the first mounting surface 356. In particular, the second mounting member 324 is configured to be detachably connected to the first mounting member 320, i.e., the second mounting member 324 can be removed and reinstalled by a user without the use of tools.

The second mounting member 324 has a second mounting surface 380 in which a plurality of magnets 384 are arranged. As with the embodiment of FIGS. 1-3, the plurality of magnets 384 enable the second mounting member 324 to magnetically mount to a ferromagnetic structure that is orthogonal to the first mounting member 320.

As is best seen in FIG. 5, each of the first and second mounting surfaces 356, 380 defines a magnet region 388, 392, respectively, that encompasses all of the associated magnets 160, 384. In particular, in the embodiment of FIG. 5, both of the magnet regions 388, 392 are rectangular and are approximately the same dimensions. The magnet region 388 of the first mounting surface 356 comprises eight linear magnets 160. The magnet region 392 of the second mounting surface 360 comprises twelve square magnets arranged in two 2×3 grids. The reader should appreciate, however, that each of the magnet regions 388, 392 may include as few as one magnet, or as many magnets as desired to enable secure mounting of the mount 308.

Additionally, in the embodiment illustrated in FIG. 5, the total surface area of the magnets 160 may be, for example, between approximately 10% and approximately 30% of the entire surface area of the magnet region 388. The total surface area of the magnets 384 in the second magnet region 392 may be, for example, between approximately 25% and approximately 65% of the entire surface area of the magnet region 392.

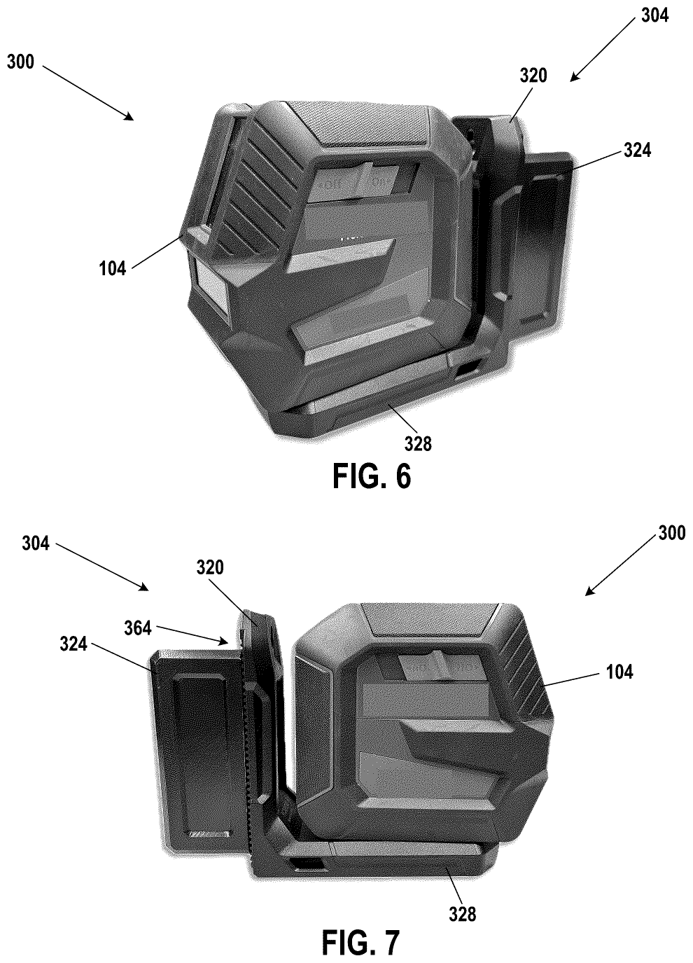

The mount 308 is used in a similar manner as the mounts 108, 208 described above. However, the configurations of the mount 308 are different from the configurations described above. In the first position of the second mounting member 324, shown in FIGS. 5 and 6, the second mounting member 324 is arranged on the right lateral side of the first mounting member 320, as viewed from the front, and extends away from the first mounting surface 356 in a direction opposite to the direction from which the horizontal member 328 extends. As a result, in the first configuration shown in FIGS. 5 and 6, the mount 308 can be attached magnetically to the corner bead 18 of a wall 10 in a similar manner as the mount 108 shown in FIG. 1. In the second configuration shown in FIG. 7, the second mounting member 324 is

removed and positioned in a second position on the opposite lateral side (i.e. the left side as viewed from the front). In the second position, the second mounting member 324 still extends in a away from the first mounting surface 356 in a direction opposite the direction the horizontal member 328 extends and is configured such that the second mounting surface 380 and the magnets 384 face inwardly toward the first mounting surface 356. In the second position of the second mounting member 324, the mount 308 can be securely mounted to the corner bead 18 facing in the other direction, i.e. facing for example to the right in the view of FIG. 1. In a third configuration, the second mounting member 324 can be disconnected from the first mounting member 320, thereby enabling the first mounting member to be installed in a conventional manner either via the magnets 164 or the through hole 336. In two additional configurations, the second mounting member 324 may be mounted on either side of the first mounting member 320 with the second mounting surface 380 and the magnets 384 facing outwardly, i.e. away from the first mounting surface 356. In either of these configurations, the mount 308 may be magnetically attached to a ferromagnetic surface with the laser level 104 extending parallel to the surface.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the foregoing disclosure.

What is claimed is:

1. A mount for a measuring device comprising:
a first mounting member having a first mounting surface that defines a first plane and includes at least one first magnet;
a second mounting member having a second mounting surface that includes at least one second magnet; and
a measuring device support configured to support the measuring device,
wherein the second mounting member has a first position at which the second mounting member extends on an opposite side of the first plane from the measuring device support and the first and second mounting surfaces are substantially perpendicular to one another.

2. The mount of claim 1, wherein the second mounting member is pivotably connected to the first mounting member via a hinge having a hinge axis that is substantially parallel to or coincident with the first plane.

3. The mount of claim 2, wherein the second mounting member has a second position at which the second mounting member extends to the same side of the first plane as the measuring device support, the first and second mounting surfaces are substantially perpendicular to one another, and the second mounting surface faces away from the measuring device support.

4. The mount of claim 3, wherein the second mounting member has a third position at which the second mounting surface is generally coplanar with the first mounting surface.

5. The mount of claim 1, wherein the second mounting member is detachably connected to the first mounting member.

6. The mount of claim 5, wherein the second mounting member has a second configuration at which the second mounting member extends on the opposite side of the first plane from the measuring device support, the first and second mounting surfaces are substantially perpendicular to one another, and the second mounting surface faces in a second direction that is opposite to a first direction the second mounting surface faces in the first position.

7. The mount of claim 1, wherein a surface area of the second mounting surface is between approximately 25% and approximately 75% of a surface area of the first mounting surface.

8. The mount of claim 1, wherein:
the first mounting surface defines a rectangular first magnet region in which all of the at least one first magnets are arranged, and
the second mounting surface defines a rectangular second magnet region in which all of the at least one second magnets are arranged.

9. The mount of claim 8, wherein a surface area of the first magnet region is approximately equal to a surface area of the second magnet region.

10. The mount of claim 8, wherein a combined surface area of all the second magnets of the at least one second magnet is between approximately 25% and approximately 65% of a surface area of the second magnet region.

11. A measuring device system comprising:
a measuring device; and
a mount comprising:
a first mounting member having a first mounting surface that defines a first plane and includes at least one first magnet;
a second mounting member having a second mounting surface that includes at least one second magnet; and
a measuring device support configured to support the measuring device,
wherein the second mounting member has a first position at which the second mounting member extends on an opposite side of the first plane from the measuring device support and the first and second mounting surfaces are substantially perpendicular to one another.

12. The measuring device system of claim 11, wherein the second mounting member is pivotably connected to the first mounting member via a hinge having a hinge axis that is substantially parallel to or coincident with the first plane.

13. The measuring device system of claim 12, wherein the second mounting member has a second position at which the second mounting member extends to the same side of the first plane as the measuring device support, the first and second mounting surfaces are substantially perpendicular to one another, and the second mounting surface faces away from the measuring device support.

14. The measuring device system of claim 13, wherein the second mounting member has a third position at which the second mounting surface is generally coplanar with the first mounting surface.

15. The measuring device system of claim 11, wherein the second mounting member is detachably connected to the first mounting member.

16. The measuring device system of claim 15, wherein the second mounting member has a second configuration at which the second mounting member extends on the opposite side of the first plane from the measuring device support, the first and second mounting surfaces are substantially perpendicular to one another, and the second mounting surface faces in a second direction that is opposite to a first direction the second mounting surface faces in the first position.

17. The measuring device system of claim 11, wherein the measuring device is a laser level.

18. The measuring device system of claim 11, wherein:
the first mounting surface defines a rectangular first magnet region in which all of the at least one first magnets are arranged, and
the second mounting surface defines a rectangular second magnet region in which all of the at least one second magnets are arranged.

19. The measuring device system of claim 18, wherein a surface area of the first magnet region is approximately equal to a surface area of the second magnet region.

20. The measuring device system of claim 18, wherein a combined surface area of all the second magnets of the at least one second magnet is between approximately 25% and approximately 65% of a surface area of the second magnet region.
